(19) United States
(12) Patent Application Publication
(10) Pub. No.: US 2010/0153205 A1
(43) Pub. Date: Jun. 17, 2010

(54) METHOD AND APPARATUS FOR ELECTRONIC MESSAGE (COUPON) DISTRIBUTION

(76) Inventors: Dale J. Retter, Scottsdale, AZ (US); Keshav D. Bandekar, Scottsdale, AZ (US)

Correspondence Address: Stoneman Volk Patent Group, P.O. Box 40070, PHOENIX, AZ, 85067-0070, US

(21) Appl. No.: 12/335,367

(22) Filed: Dec. 15, 2008

Related U.S. Application Data
(63) Continuation of application No. 11/317,283, filed on Dec. 22, 2005, now abandoned.

(51) Int. Cl. G06Q 30/00; G06Q 10/00; G06F 17/30; G06F 12/14

(52) U.S. Cl. 705/14.26; 705/14.36; 707/802; 713/189; 707/E17.005

(57) ABSTRACT

A system and method for creating and retrieving coupons using an electronic coupon database includes registering coupons with the database by a vendor, and then registering cell phones, also with the database; so that cell phones subsequently can request coupons from the database. The coupons are encrypted and sent to the requesting registered cell phone, which then decrypts the coupons for display and redemption at a point of sale. Provision is made to prevent the transfer of coupons from the requesting cell phone to some other cell phone in the system.

### CROSS-REFERENCE TO RELATED APPLICATION

The present application is a continuation of prior nonprovisional application Ser. No. 11/317,283, filed Dec. 22, 2005, entitled “METHOD AND APPARATUS FOR ELECTRONIC MESSAGE (COUPON) DISTRIBUTION”, the contents of which are incorporated herein by this reference and are not admitted to be prior art with respect to the present invention by the mention in this cross-reference section.

### BACKGROUND

Special offers and coupons, generally providing a discount or a fixed price reduction, are widely offered for the purpose of stimulating customer purchases at various merchants. Typically, these special offers and coupons are divided into two general types. A first type of special offer and coupon may be considered to be unlimited or broadcasted coupons. These are offers or coupons which the issuer does not wish to restrict as to who may use them, or how many people or times the coupon or special offer might be used, based on anything other than criteria determined independently of the customer wishing to take advantage of the offer.

An example of an unlimited special offer which might be published in a Yellow Page advertisement or a newspaper advertisement might state “$10—All you can eat fish special dinner every Friday, from 5:00 PM to 8:00 PM.” It is apparent that the coupon issuer or special offer issuer has no desire to restrict who might take advantage of this offer, or how many times the offer may be used by any individual. This is an example of a user-unrestricted offer. The restrictions (only on Fridays and only during the specified hours) are based on criteria determined independently of the user of the offer or coupon.

A second type of special offer and coupon may be considered to be user-restricted-use coupons or special offers. Offers of this type, or coupons of this type, are such that in addition to any possible general restrictions determined independently of the customer or user desiring to take advantage of the offer (as in the above example), the issuer does wish to restrict or limit the use for a specific individual user. For example, an Entertainment Book may be purchasable for a significant cost by a user. The book may have a single coupon in it which states “the coupon entitles the customer to one dinner free with the purchase of a second dinner of equal or greater price.” Here, it clearly is the intent of the issuer to restrict each Entertainment Book purchaser to only one of such discounts.

A common reason for restricted use coupons is that the coupon or special offer is of such a great value that the issuer is willing to give it to a potential new customer only once, in order to get that customer to try the product or service in the hope that the offer will make the customer more likely to use or purchase that service again in the future. The issuer is not willing to provide this discount or special offer for multiple uses by the same customer. In practice, this result ensured by the coupon issuer requiring that the coupon be surrendered to the business at the time the offer is used; so the business can make sure that the coupon is not used on a second occasion by the same customer. A variant of this physical coupon system also is used, whereby purchasers or recipients receive a special membership or club card that has numbers or markings for individual offers which can be scratched off, marked, or modified to signify that they have been used once, and therefore cannot be used again by the owner of that particular card.

Most coupons and special offers presently utilize a physical coupon or object (such as a membership card) as a means of achieving a user-restricted-use coupon/special offer, as described above. At present, electronically transmitted coupons may not be restricted in a way which achieves a similar result. For example, if a restaurant owner wishes to offer a free dinner with the purchase of an equal or more expensive dinner to an individual on a one time only basis, there is no practical way to do this with an electronically distributed offer. If the restaurant owner wants to make such an offer via the Internet or via a mobile wireless device, currently there has been no way to prevent or even track multiple uses by the same customer.

It is desirable to provide an improved message/coupon delivery and redemption system and method.

### SUMMARY OF THE INVENTION

An electronic coupon system including: a vendor coupon database for storing unique coupon identifiers for a plurality of coupons; means for comparing the identifier of a coupon presented on a cell phone for redemption with the coupon identifiers in the coupon database to provide an output based on the comparison results; and means responsive to the output of the comparing means for accepting or rejecting a presented coupon. Moreover, it provides such an electronic coupon system further including means for modifying the vendor coupon database responsive to acceptance of a presented coupon. Additionally, it provides such an electronic coupon system wherein the means for modifying the vendor coupon database includes removing the identifier of an accepted coupon from the database. Also, it provides such an electronic coupon system wherein the means for modifying the vendor coupon database increments the redemption count for the plurality of coupons upon acceptance of a presented coupon. In addition, it provides such an electronic coupon system further including means for deleting coupons from the coupon database upon acceptance of coupons. And, it provides such an electronic coupon system further including means for removing an accepted coupon from the cell phone. Further, it provides such an electronic coupon system wherein the means for modifying the vendor coupon database increments the redemption count for the plurality of coupons upon acceptance of a presented coupon. Even further, it provides such an electronic coupon system further including means for removing an accepted coupon from the cell phone.

In accordance with another preferred embodiment hereof, this invention provides a coupon retrieval system including in combination: means for registering a cell phone in a system database; means for registering vendor information and coupon information in the system database; and means for supplying a coupon from the database to a registered cell phone user upon request initiated by the cell phone user. Moreover, it provides such a coupon retrieval system wherein the means for registering cell phone in the system database includes means for equipping a registered cell phone with a unique private key, and wherein the means for supplying a coupon from the database to a registered cell phone user encrypts such coupon information with the unique private key associated with the registered cell phone. Additionally, it provides such a coupon retrieval system further including means for precluding transference of coupon information in the system database from one registered cell phone to another registered cell phone in the system. Also, it provides such a coupon retrieval system further including means for modifying the coupon information in the system database upon supplying of a coupon from the database to a registered cell phone user. In addition, it provides such a coupon retrieval system further including means for modifying the coupon information in the system database upon supplying of a coupon from the database to a registered cell phone user.

In accordance with another preferred embodiment hereof, this invention provides a coupon retrieval system further including means for modifying the coupon information in the system database upon supplying of a coupon from the database to a registered cell phone user.

In accordance with another preferred embodiment hereof, this invention provides a coupon retrieval system including in combination: a coupon delivery source; and a cell phone registered with the coupon delivery source and having a unique identification number associated with coupons to be received thereby from the coupon delivery source. And, it provides such a coupon retrieval system wherein coupons to be received by the cell phone are encrypted and the cell phone includes means for decrypting the encrypted coupons.

In accordance with another preferred embodiment hereof, this invention provides a method for creating and retrieving coupons comprising the steps of: establishing a coupon database; supplying coupon information for coupons to be redeemed from the coupon database by a vendor; registering cell phones with the coupon database for enabling registered cell phones subsequently to obtain coupons from the database; providing registered cell phones with unique decryption codes; supplying encrypted coupon information to a registered cell phone upon request for such a coupon from the registered cell phone to the coupon database; encrypting the coupon information with the unique encryption code for the requesting cell phone; and decrypting a received requested coupon at the registered cell phone for subsequent presentation and redemption. Further, it provides such a method further including removal of a requested coupon from the requesting registered cell phone following redemption of the coupon. Even further, it provides such a method further including modifying the coupon database upon redemption of a coupon by a requesting registered cell phone. Even further, it provides such a method wherein the modifying of the coupon database comprises removing a coupon from the coupon database.

### BRIEF DESCRIPTION OF THE DRAWINGS

FIG. 1 is a block diagram of a preferred embodiment of the invention.

FIG. 2 is a flow chart illustrating features of the embodiment shown in FIG. 1.

FIG. 3 is a flow chart of features of the embodiment shown in FIG. 1.

FIG. 4 is a flow chart of additional features of the embodiment shown in FIG. 1.

FIG. 5 is a flow chart of additional features of the embodiment shown in FIG. 1.

FIG. 6 is a flow chart of features of the embodiment shown in FIG. 1.

FIG. 7 is a flow chart of features of the embodiment shown in FIG. 1.

### DETAILED DESCRIPTION OF THE BEST MODES AND PREFERRED EMBODIMENTS OF THE INVENTION

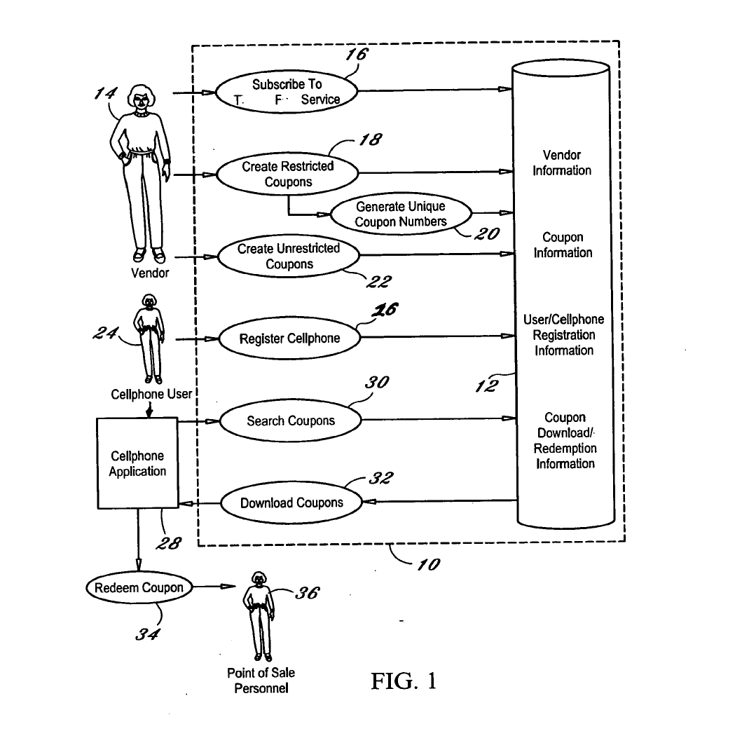

Reference now should be made to the drawings, in which the same reference numbers are used throughout the different figures to designate the same or similar components. FIG. 1 is a block system diagram of a message request and retrieval system particularly useful in delivering coupons and special offers to cell phones or other mobile devices. Such devices are identified herein as cell phones, and specifically include cell phones, mobile phones, personal digital assistants (PDA), and other devices of a portable nature capable of receiving and/or sending and displaying messages. Also, as used herein, the term “coupon” means coupons, special offers, discounts (restricted and unrestricted), and the like.

The system shown in FIG. 1 illustrates an embodiment of the invention in which a vendor 14, such as a coupon-issuer or a manufacturer or merchant desiring to supply special messages to interested customers on request, subscribes to the service, which is identified for purposes of reference here in as a TF service 16. The TF service 16 itself may include a system administration computer linked to the vendor 14 and other users of the system by way of the Internet, direct wire systems, or the like, capable of interconnecting the various users of the system with one another in accordance with the system protocol.

As illustrated in FIG. 1, a vendor or coupon supplier 14 subscribes to the TF service at 16, by way of a suitable link 10, which may be a hard wired link, or more typically, a wireless link through the Internet 10. When a vendor 14 subscribes to the TF service at 16, various vendor information is supplied to and stored in the TF database or memory 12 uniquely identifying that vendor with a specific vendor account administered by the TF system. The particular details of the account and manner in which payment is requested and remitted is not important to an understanding of the present invention, and may be effected in any conventional manner. The vendor 14 is uniquely identified; and the vendor information is stored in the memory 12, as indicated in FIG. 1.

Based on the nature of the vendor account, the vendor 14 may create two different types of coupons. One of these is considered an unrestricted coupon, which then is transmitted, identified, and formatted by the vendor through a link 22 to the memory 12, where the coupon information is stored and formatted. Unrestricted coupons may be of the general type described above, and they may be unlimited in number, or they may be specifically limited to a fixed number, depending upon the relationship which the vendor 14 has with the TF service 16.

The vendor 14 also may create what is known as a restricted coupon 18, which also is supplied to the memory 12. The configuration of the restricted coupon 18 and the particular details of the coupon are stored in the memory 12 for subsequent release or transmission. In conjunction with restricted coupons 18, the vendor 14 typically generates unique coupon numbers 20 to sequentially identify the coupons 18; so that upon the redemption of a specific restricted coupon, information may be sent back to the TF service 16 and the memory 12 to identify that a specific restricted coupon has been redeemed. This information then can be used either to delete the coupon from the system, or simply to accumulate a count or restricted coupons used. The particular use which is made of the restricted coupon redemption and tabulation is effected in accordance with the agreement between the vendor 14 and TF service 16.

As described subsequently, steps are taken to ensure the security of the vendor 14, the coupons being created, and the identity of the ultimate user 24 of the coupons. For the purposes of understanding FIG. 1, however, it should be noted that a cell phone user 24 who desires to participate in the coupon distribution system registers the number of the cell phone or PDA 26 with the TF service, where cell phone registration information is stored in the database 12, as indicated in FIG. 1.

In registering a cell phone, the cell phone user 24 creates the user's own profile on-line with the memory database 12. When a user 24 first takes the initial steps to register the cell phone/PDA device 26, the cell user 24 enters the make and model of the cell phone being used. Based on the make and model of the cell phone, the system sends a link to the cell phone via SMS/e-mail. This link points to a TF coupon application protocol (TF-CAP) compatible with the make and model of the cell phone, since different cell phones from different manufactures have differing operational characteristics.

The user 24 has ability to update the make and model of the cell phone whenever a change is made by the user 24 from one cell phone to another. The system also typically requests further identification from the cell phone user 24 in addition to the make and model of the cell phone and the cell phone number being registered. That information is stored in the memory database 12 as user/cell phone profiles and is stored on a secure basis.

Once a cell phone user 24 is registered, that user 24 can initiate a search for coupons through the cell phone application 28, via the search coupons 30 to the database 12. Specific coupons may be requested by the cell phone user 24, or a specific class of coupons may be requested. The TF service responds to the request, and then supplies download coupons 32 back to the cell phone application 28 for the cell phone user 24. The cell phone user 24 then has the option of storing and displaying the coupons of interest and discarding any others.

The final step in the operation of the overall system is for the cell phone user 24, after applying for and receiving the downloaded coupons 28, to redeem the coupons at 34 with a point of sale (POS) personnel 36. Typically, the coupons 34 are displayed on the screen of the cell phone in a format which provides a visual image of the coupon for the point of sale personnel 36. Ideally, the coupon also includes a bar code, which permits the direct reading of the coupon by the point of sale personnel 36, when the coupon is redeemed at 34, as shown in FIG. 1.

It should be noted that the point of sale personnel 36 at the business honoring the coupon can examine the coupon to determine whether or not that coupon is to be honored. If the coupon is to be honored, and if it further includes a bar code representation on it, entry of the coupon at the point of sale by the personnel 36 is readily effected by means of a bar code scanner or similar device. Additional information, particularly in the case of restricted coupons, will appear in conjunction with the coupon; so that if the business wishes to ensure that the offer is not again submitted by the same cell phone user 24, and by the particular cell phone used by that user, a delete key sequence, indicated on the coupon itself, is entered by the point of sale personnel 36, either directly to the cell phone or in conjunction with the downloaded reading of the coupon by the bar code reader on the cash register or data entry device used by the point of sale personnel 36.

In conjunction with the system which has been described relative to FIG. 1, several features are employed in order to ensure the coupon delivery system most effectively meets the desires of vendors using the system, as well as users desiring to obtain coupons from the system for ultimate presentation at a point of sale location. Among these features are the authorized transfer (via the TF service) of the electronic coupon special offer which transmits the coupons by way of wireless/Internet/computer data transmission to a cell phone only to a specifically identified cell phone number. No unrestricted broadcasting of coupons is effected.

The transmission of coupons and special offers is initiated only through an active request by the cell phone user 24. Cell phone users/owners 24 are invited to request electronic coupons or special offers through a broad spectrum of existing advertising media including: Internet web sites and advertising, print and broadcast media. User initiated phone-information calls, text messages, or e-mail requests also may be used by a cell phone user 24 to request coupons and special offers provided by the system.

The transmission of the coupons and special offers in the system of FIG. 1 is achieved using key encryption methods. A separate/individualized pair of keys, namely, “public key” and “private key”, is generated for every subscribing cell phone user 24. The coupon or special offer is encrypted using the public key for the intended recipient cell phone, and is sent to the cell phone of that cell phone user 24 at the cell phone application 28. The encrypted coupon can only be decrypted by using the corresponding private key from the key pair generated for the unique particular cell phone at the cell phone application 28. The coupon can only be vied in a recognizably displayed form by a software viewing program which contains this private key. The purpose of the private key is to prevent the display or reproduction of the coupon separate from the specific cell phone to which it is transmitted at the cell phone application 28 at the request of the cell phone user 24.

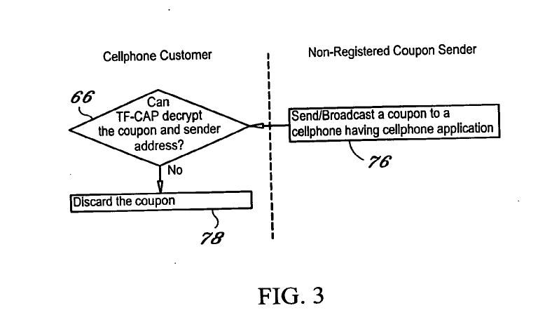

If a coupon is transmitted to a cell phone which is not encrypted using the public key individualized for the specific cell phone application 28 to which it is sent, it will be rejected by the recipient. This blocks the recipient from coupons sent by unauthorized users who do not possess the specific code (private key) required to initiate acceptance of the coupon by the receiving device. This is explained in greater detail in conjunction with FIG. 3.

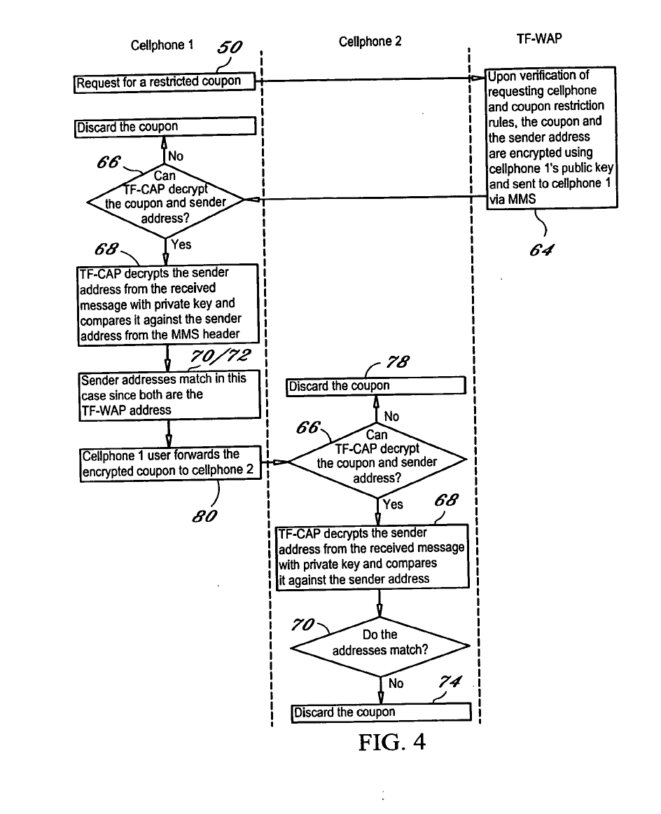

If a sent coupon is reproduced or re-transmitted to another cell phone or device, then, since the new recipient cell phone does not have a private key or has a different private key, the coupon cannot be decrypted, and it would be rejected and not displayed by the software at that other cell phone. This is described in greater detail in conjunction with FIG. 4.

In order to effectively control the transfer of coupons from the database memory 12 to a requesting cell phone user application 28, the transmitted coupon carries the originator phone number (phone number of the system linked to the vendor 14 transmitting the coupon) as part of the encrypted message. The software in the cell phone application 28, used to display the coupon on the cell phone of the cell phone user 24, decrypts the message, pulls up the originator phone number and matches it against the “from” field of the message header. If the two fields do not match, the software at the coupon application 28 rejects the coupons. This prevents the reproduction of a coupon through forwarding it by the cell phone user 24 itself, or forwarding the coupon to some other cell phone and having the same coupon then forwarded back to the original requester 24.

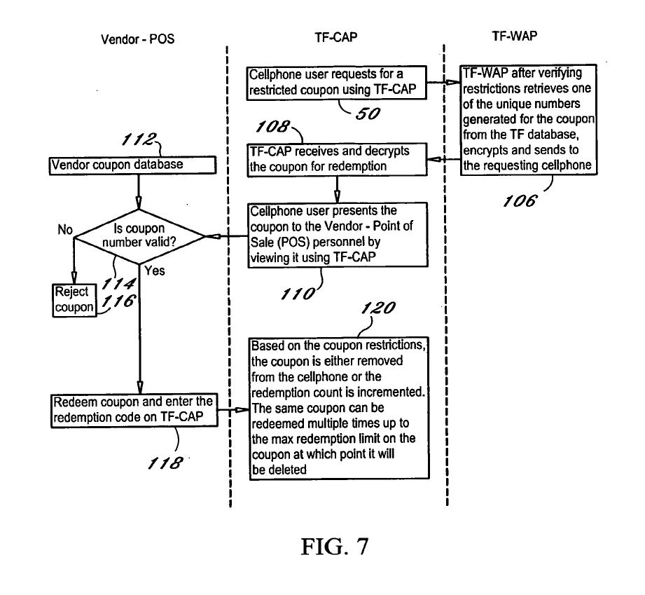

As noted in greater detail in conjunction with FIG. 7, the authorized transmission of an electronic coupon or special offer keeps a record of the mobile phone members or cell phone user numbers at the cell phone application 28, to which it has transmitted coupons and limits the repetition of transmission of restricted coupons to comply with the desires of the coupon/special offer issuer 14. For example, only one such coupon per cell phone customer 24, or once every month, or once every six months may be effected and controlled by the system, since the specific coupons and the recipients are tracked, as described in greater detail subsequently.

The system operates such that when a request is made by a cell phone user 24 through a cell phone application for a specific coupon, a specific cell phone number to which the coupon is to be sent must be provided by the requesting party 24. Subsequent to the receipt of a request for a specific coupon or special offer, an automated system under control of the database 12 dials the specified number provided by the requesting cell phone user 24. If the cell phone application 28 of the cell phone user 24 then answers the call made by the automated system, a recorded message identifying the caller as a responder to the request for a coupon or special offer download is played. If the recipient 24/28 has not installed (or the phone being used by the cell phone user 24 did not come equipped with) a coupon/special offer interface program, this will be described to the cell phone user 24, along with an identification of the cell phones which support the program. If the cell phone of the cell phone user called supports the download program, the cell phone user 24 will be offered a choice of canceling or accepting to have the coupon/special offer program downloaded, followed by the requested coupon.

If the cell phone application 28 of the cell phone user 24 answers the call and already has a coupon/special offer interface program installed in it, the recipient or cell phone user 24 simply is offered the choice of canceling or accepting to have the requested coupon or special offer downloaded to the phone at the cell phone application 28.

The coupon/special offer interface program to be installed in the cell phone application 28 typically has a number of basic functions. As mentioned above, this software identifies or verifies the telephone number of the cell phone on which it is installed as being the number called by the system attempting to deliver coupons. This software works in conjunction with the coupon data supplied by the TF system to facilitate the downloading of coupons and special offers in the cell phone application 28.

The coupon/special offer interface program to be installed in the cell phone application 28 typically has a number of basic functions. As mentioned above, this software identifies or verifies the telephone number of the cell phone on which it is installed as being the number called by the system attempting to deliver coupons. This software works in conjunction with the coupon data supplied by the TF system to facilitate the downloading of coupons and special offers in the cell phone application 28. The software further rejects receipt of any coupons, messages or special offer transmissions if a code which matches with the individual code sent is not contained with such coupon/special offer transmissions or messages. The interface program also sends a confirmation back to the TF system and database 12 that the offer sent to the specific telephone number has been successfully installed. Activation of the offer typically is delayed until confirmation of receipt is sent, if desired.

Additional features which may be provided by the interface program include an installed directory and sub-directory system which may be browsed by the user 24. Such directories allow a user to select a sub-directory category and request downloads of special offer titles for that category. In addition, a user may be allowed to select a single title or group of titles and then download selected special offers corresponding to those titles or groups of titles. Uninstall commands which allow the cell phone user 24 the option to completely remove a selected coupons or special offer file or group of files are desirable, as well as an “uninstall” command to allow the cell phone user 24 to completely remove the interface program at will.

Basically, the installed coupon or special offers are in the form of small files which have five basic functions:
A. The files contain code which matches with the unique code of the recipient cell phone (cell phone application 28) as a prerequisite or acceptance and display.
B. Display the offer on the cell phone of the user 24 when selected.
C. Allow for sub-displays (with additional details or information) to be selected and displayed by the cell phone user 24.
D. Display a key sequence which causes the coupon/special offer to be deleted.
E. Contain the telephone number of the issuer which may be directly dialed by pressing an indicated key or keys, if such a feature is desired by the coupon issuer 14.

Once a coupon or special offer is downloaded to the cell phone of the cell phone user 24, the user 24 is able to scroll through a list of installed coupons and display them at will.

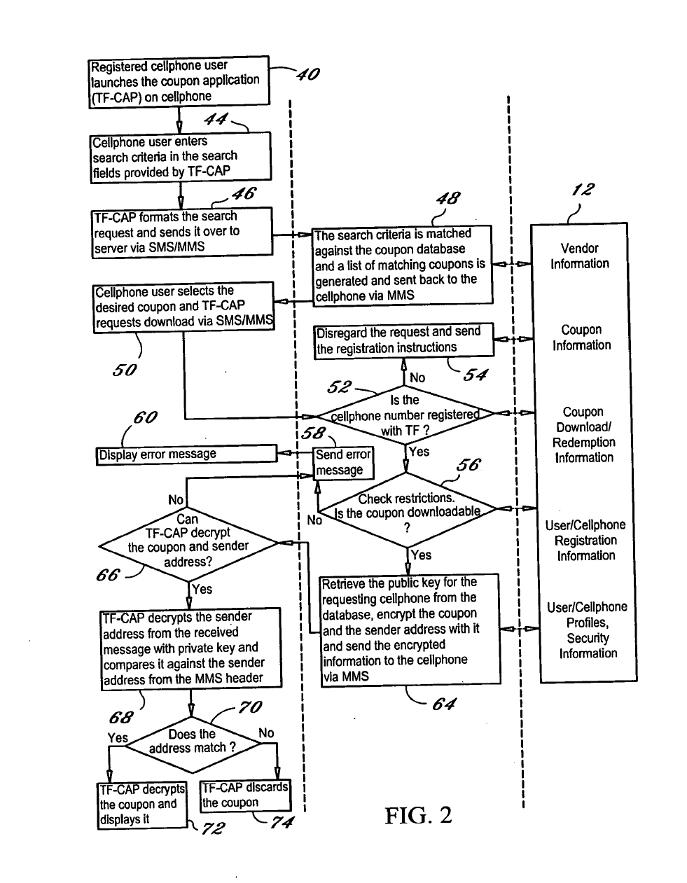

Reference now should be made to FIG. 2, which is a flow chart of the manner in which the system operates in response to a request by a cell phone user 24 for a coupon available in the database 12 from coupon information previously provided by a vendor 14. As shown in FIG. 2, a registered cell phone user launches a coupon application through the coupon application protocol (TF-CAP) on the user's cell phone at 40. At 44, the cell phone user enters the criteria in the search fields provided by the TF-CAP. At 46, the TF-CAP formats the search based on the search criteria provided by the cell phone user, and sends the search request to theft service server via SMS/MMS or http. The search criteria is matched at 48 against the coupon database; and a list of matching coupons is generated and sent back to the cell phone via MMS/SMS HTTP at 50. It should be noted that the matching at 48 is based on coupon and vendor information located in the database 12.

The cell phone user at 50 then selects the desired coupon from the list of coupons sent to the user; and TF-CAP requests download of that coupon via SMS/MMS or http. When this information is requested, the TF web application protocol (TF-WAP) checks at 52 to determine whether the cell phone number making the request is registered with the TF system. If the answer is “no”, the coupon request is disregarded at 54; and registration instructions are sent back to the cell phone user 24 for the purposes mentioned previously to allow the cell phone user 24 to register in the system, as indicated generally in the discussion of FIG. 1.

If the cell phone number already is registered with the TF service, as determined by a check of the database 12, the restrictions on the requested coupon are checked at 56 to determine whether the coupon is downloadable. If the coupon is not downloadable, an error message is generated at 58; and the error message is displayed on the screen of the cell phone user at 60. On the other hand, if there are no restrictions and the coupon is downloadable, that determination is made at 56. The public key for the requesting cell phone is obtained from the database 12, the coupon is encrypted, and the sender address is encrypted with it at 64. This encrypted information then is sent to the cell phone by way of MMS or http at 64.

At 66, the cell phone of the cell phone application 28 (FIG. 1) determines whether the TF-CAP (TF coupon application protocol) software is installed, and whether the cell phone can decrypt the coupon and the sender address. If the answer is “no”, the error message at 58 is generated and displayed at 60. If the answer at 66, however, is “yes”, the TF-CAP decrypts the sender address from the received message with the private key described above and compares it against the sender address from the MMS header. If the addresses match at 70, the TF-CAP decrypts the coupon and displays it on the cell phone screen at 72. On the other hand, if the addresses do not match at 70, the TF-CAP discards the coupon at 74; and it is not displayed.

As mentioned above in conjunction with the flow chart of FIG. 2, coupon requests are initiated in this system by a registered cell phone user at 40. Coupons are not sent to the cell phone user unless a request has been made by the cell phone user. In FIG. 3, a situation is illustrated where a non-registered coupon sender sends a broadcast coupon to a cell phone (or multiple cell phones) having a cell phone application at 76. The unrequested coupons will be sent to the cell phone customer, since the broadcast coupon sender has the telephone number of that cell phone, and most likely, many others. When a registered cell phone user having a TF-CAP application installed, however, receives such a non-registered coupon, a decision is made by the TF-CAP software as to whether it can decrypt the coupon and the sender address at 66. Since the non-registered coupon does not include the necessary encryption to allow the cell phone customer to respond at 66, the TF-CAP cannot decrypt the coupon and the sender address; and the coupon is discarded at 78. This feature of the system allows it to prevent unwanted receipt of coupons and special offers, and allows the cell phone user's individual cell phone application 28 to reject “spam” or unwanted coupons and special offers.

The system also is designed to prevent unwanted redistribution or duplication of coupons and special offers or membership identification or loyalty benefit entitlements. This is designed to prevent the forwarding of properly received coupons or special offers from a first cell phone to a second cell phone. The manner in which this unwanted re-distribution (from coupon venders) is prevented is shown in FIG. 4.

In FIG. 4, cell phone 1 makes a request for a restricted coupon at 50. This request is made in the manner described previously in conjunction with FIG. 2; and for the purposes of the present discussion, the cell phone 1 is considered to be a registered coupon recipient. The request is made as described previously in conjunction with FIG. 2 to the TF-WAP (wireless application protocol); and at 64, upon verification of requesting cell phone and coupon restriction rules, the coupon and the sender address are encrypted using the public key for cell phone 1. This information then is sent to cell phone 1 via MMS/HTTP, as described previously. At the requesting cell phone, the decision is made at 66 “can TF-Cap decrypt the coupon and sender address.” This is the same as described at step 66 of FIG. 2. If the answer is “no,” the coupon is discarded. If, however, at 66 the coupon can be decrypted along with the sender address from the received message with the private key and compare it against the sender address from the MMS/HTTP reader. Assuming the address matches at 70/72, since both are the TF-WAP address, the cell phone user 1 receives the requested coupon via http/MMS, direct cable, as an email, or other protocol as described above. Assume cell phone user 1 then attempts to forward the encrypted coupon to a second cell phone 2 at 80.

When an attempt is made to forward an encrypted coupon to cell phone 2, the TF-CAP software makes a decision again at 66 whether it can decrypt the coupon and sender address. If the answer is “no,” the coupon is discarded at 78. If the coupon and sender address can be decrypted at 66, a decision is then made at 68 where the sender address is decrypted from the received message with the private key, and compared against the sender address. The next decision is made at 70, as to “do the addresses match?” the answer is “no”; and the coupon is discarded at 74.

The reason the addresses do not match at 70 is that the sender addresses cannot match, since the encrypted address is the TF-WAP address whereas the one from the header is that of the cell phone 1, rather than cell phone 2. Through the use of the public key and private key system employed, unauthorized reproduction of coupons is prevented. This provides insurance to a vendor distributing restricted use coupons that those coupons are only used once (or only as often as determined by the vendor), and only are used by an authorized recipient of those coupons.

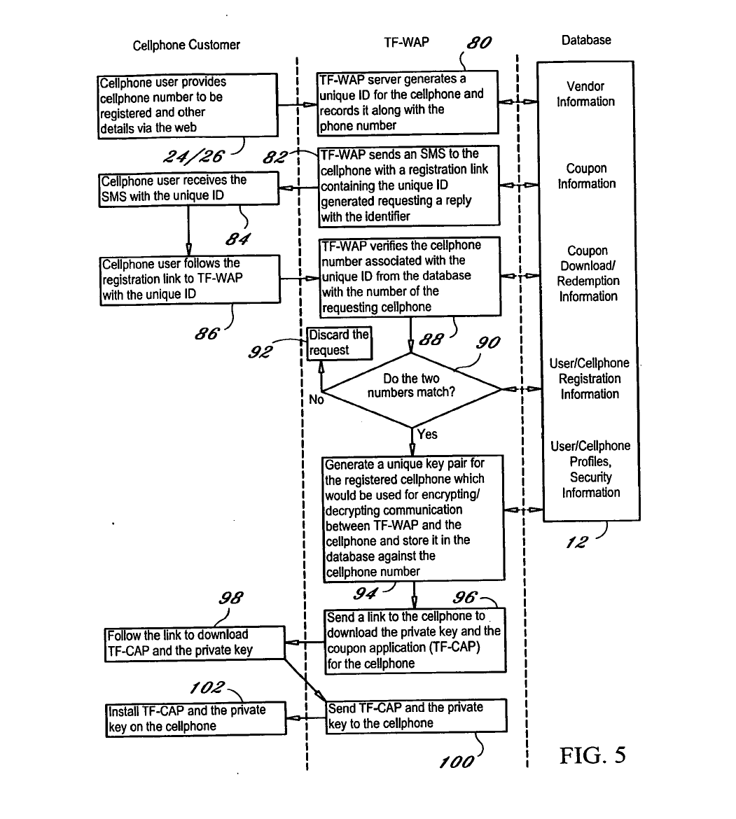

Reference now should be made to FIG. 5, which illustrates in greater detail a flow chart of the manner in which a cell phone user 24 initiates registration of the particular cell phone with the system. as shown at 24/26 in FIG. 5, the cell phone user provides the number of the cell phone to be registered and other details by way of the WAP to the TF-WAP server at 80. The TF-WAP server generates a unique identification (ID) for the requesting cell phone and records that ID, along with the phone number, in the database 12. At 82, the TF-WAP sends an SMS/e-mail message to the cell phone with a registration link containing the unique ID generated, requesting a reply with the identifier. At 84, the cell phone receives the SMS/e-mail with the unique ID; and at 86, the cell phone user follows the registration link to the TF-WAP with the unique ID.

At 88, the TF-WAP verifies the cell phone number associated with the unique ID from the database, with the number of the requesting cell phone; and a decision is made at 90 as to whether the two numbers match. If the numbers do not match, the request is discarded at 92. If they do match, and they should for a valid cell phone registration protocol, the next step, at 94, is to generate a unique public/private key pair for the registered cell phone which is used for encrypting/decrypting communication between TF-WAP and the registered cell phone. This key pair is stored in the database 12 against the cell phone number, via the link from 94 to the database 12.

At 96, a link is sent to the cell phone to download the private key and the coupon application software (TF-CAP) for that particular cell phone. At 98, the link is followed to download the TF-CAP and the private key in the cell phone. At 100, the TF-CAP and the private key are sent to the cell phone; and it is installed at 102 on the cell phone. The cell phone application 28 (FIG. 1) then is prepared for use by the cell phone user 24 in the manner described previously in conjunction with the operation of the system shown in FIG. 1.

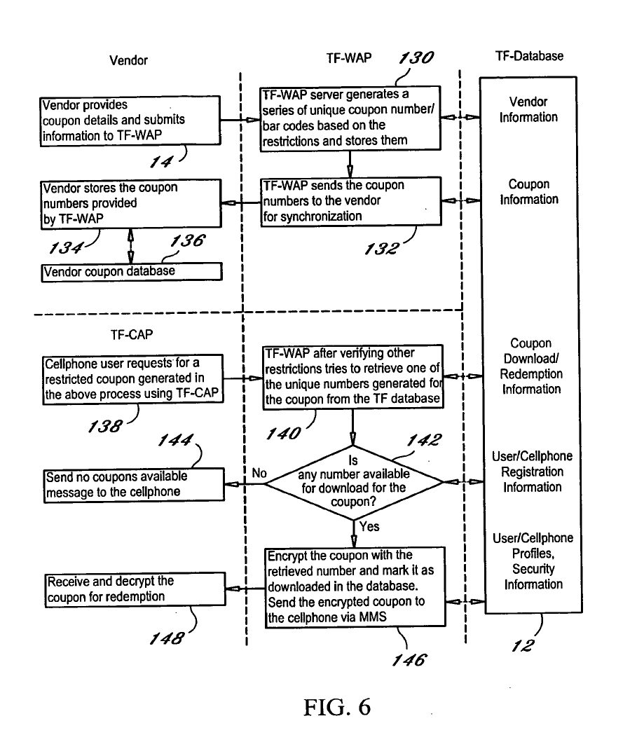

FIG. 6 is directed to the manner in which a vendor 14 produces a restricted coupon and the manner of retrieval of such coupons. A vendor at 14 provides coupon details and submits that information to the TF-WAP. The TF-WAP server at 130 generates a series of unique coupon numbers or bar codes based on the restrictions provided by the vendor, and stores these in the TF database 12. After these coupons and restrictions are stored, the TF-WAP sends the coupon numbers to the vendor for synchronization at 132. The vendor typically stores the coupon numbers provided by the TF-WAP at 134 in a vendor coupon database 136. This database subsequently is used by the vendor 14 when those coupons are redeemed by potential customers.

In conjunction with the restricted coupon system, retrieval is effected by a cell phone user requesting a restricted coupon generated in the process described above (FIG. 2), using TF-WAP at 138. The request is supplied to TF-WAP at 140; and after verifying other restrictions, TF-WAP attempts to retrieve one of the unique numbers generated for the coupon from the TF database 12. If any number is available for downloading, the decision is made at 142. If there are no further numbers for that coupon available for downloading, the decision is “no” and a “no coupons available” message is sent to the cell phone at 144. If, however, a number for the requested coupon is available at 142, the coupon is encrypted at 16 with the retrieved number, and marked as “downloaded” in the database. This causes a change in the number of restricted coupons available in the database 12, either by simply reducing the number originally supplied by the vendor, or specifically deleting a particular coupon number. The encrypted coupon then is sent to the cell phone via MMS or http at 146, and is received and decrypted at 148 by the cell phone.

FIG. 7 illustrates the manner in which a restricted coupon is redeemed. As mentioned in conjunction with FIG. 6, a cell phone user requests a restricted coupon at 50 using TF-CAP. The TF-WAP at 106, after verifying the restrictions, retrieves one of the unique numbers generated for the coupon from the TF database 12 and encrypts and sends the coupon to the requesting cell phone. At 108, TF-CAP of cell phone user receives and decrypts the coupon for redemption; and the coupon is displayed on the cell phone screen of the requesting user. At 110, the cell phone user presents the coupon to the vendor or point of sale (POS) personnel by displaying the coupon on the screen of the cell phone using the TF-CAP.

At the vendor, a determination is made as to whether the coupon number is valid at 114. This is done in conjunction with a comparison of the proffered coupon with the vendor coupon database 112, which as mentioned previously is in parallel with the coupon information stored in the TF database 12. If the coupon number no longer is valid, the decision is made to reject the coupon at 116. However, if the coupon determination at 114 is that the number is valid, the coupon is redeemed at 118; and the redemption code is entered on the TF-CAP.

As noted at 120, based on the coupon restrictions, the coupon is either removed from the cell phone by direct operation of designated keys on the cell phone with the coupon displayed, as described previously; or the redemption count in the database 12 and the vendor coupon database 112 is incremented. The same coupon possibly may be redeemed multiple times, up to a maximum redemption unit on the coupon (previously established by a vendor), at which point further coupons would be deleted from both databases 12 and 112. The particular restrictions and the manner of deletion are established initially, as described above in conjunction with the original entry of the coupon into the TF database. It should be noted however that the point of sale personnel 36 (FIG. 1) and at 118 in FIG. 7 are provided with the ability to delete a particular coupon from further potential redemption, either through the TF terminal, or directly through the cell phone of the cell phone user 24 presenting the coupon for redemption.

The manner in which deletion of a coupon or a coupon from a series of coupons is effected can be accomplished in different ways; but it should be noted that the POS personnel 36 are provided with the capability of canceling such restricted coupons after presentation and acceptance. This is similar to the physical retrieval of a printed or paper coupon, but with the added protection that, unlike a printed coupon which readily may be fraudulently reproduced, the electronic deletion of a coupon issued through the encryption network described previously ensures that only a single use (or designated multiple user) of a coupon is effected, if such single use is desired by the vendor issuing the coupon.

The foregoing description of a preferred embodiment of the invention is to be considered as illustrative and not as limiting. Various changes and modifications will occur to those skilled in the art for performing substantially the same function, in substantially the same way, to achieve substantially the same result, without departing from the true scope of the invention as defined in the appended claims.

What is claimed is:

1) An electronic coupon system including:
a) a vendor coupon database for storing unique coupon identifiers for a plurality of coupons;
b) means for comparing the identifier of a coupon presented on a cell phone for redemption with the coupon identifiers in the coupon database to provide an output based on the comparison results; and
c) means responsive to the output of the comparing means for accepting or rejecting a presented coupon.

2) The electronic coupon system according to claim 1 further including means for modifying the vendor coupon database responsive to acceptance of a presented coupon.

3) The electronic coupon system according to claim 2 wherein the means for modifying the vendor coupon database includes removing the identifier of an accepted coupon from the database.

4) The electronic coupon system according to claim 3 wherein the means for modifying the vendor coupon database increments the redemption count for the plurality of coupons upon acceptance of a presented coupon.

5) The electronic coupon system according to claim 1 further including means for deleting coupons from the coupon database upon acceptance of coupons.

6) The electronic coupon system according to claim 5 further including means for removing an accepted coupon from the cell phone.

7) The electronic coupon system according to claim 2 wherein the means for modifying the vendor coupon database increments the redemption count for the plurality of coupons upon acceptance of a presented coupon.

8) The electronic coupon system according to claim 1 further including means for removing an accepted coupon from the cell phone.

9) A coupon retrieval system including in combination:
a) means for registering a cell phone in a system database;
b) means for registering vendor information and coupon information in the system database; and
c) means for supplying a coupon from the database to a registered cell phone user upon request initiated by the cell phone user.

10) The coupon retrieval system according to claim 9 wherein the means for registering cell phone in the system database includes
a) means for equipping a registered cell phone with a unique private key, and
b) wherein the means for supplying a coupon from the database to a registered cell phone user encrypts such coupon information with the unique private key associated with the registered cell phone.

11) The coupon retrieval system according to claim 10 further including means for precluding transference of coupon information in the system database from one registered cell phone to another registered cell phone in the system.

12) The coupon retrieval system according to claim 10 further including means for modifying the coupon information in the system database upon supplying of a coupon from the database to a registered cell phone user.

13) The coupon retrieval system according to claim 9 further including means for modifying the coupon information in the system database upon supplying of a coupon from the database to a registered cell phone user.

14) The coupon retrieval system according to claim 11 further including means for modifying the coupon information in the system database upon supplying of a coupon from the database to a registered cell phone user.

15) A coupon retrieval system including in combination:
a) a coupon delivery source; and
b) a cell phone registered with the coupon delivery source and having a unique identification number associated with coupons to be received thereby from the coupon delivery source.

16) The coupon retrieval system according to claim 15 wherein coupons to be received by the cell phone are encrypted and the cell phone includes means for decrypting the encrypted coupons.

17) A method for creating and retrieving coupons comprising the steps of:
a) establishing a coupon database;
b) supplying coupon information for coupons to be redeemed from the coupon database by a vendor;
c) registering cell phones with the coupon database for enabling registered cell phones subsequently to obtain coupons from the database;
d) providing registered cell phones with unique decryption codes;
e) supplying encrypted coupon information to a registered cell phone upon request for such a coupon from the registered cell phone to the coupon database;
f) encrypting the coupon information with the unique encryption code for the requesting cell phone; and
g) decrypting a received requested coupon at the registered cell phone for subsequent presentation and redemption.

18) The method according to claim 17 further including removal of a requested coupon from the requesting registered cell phone following redemption of the coupon.

19) The method according to claim 17 further including modifying the coupon database upon redemption of a coupon by a requesting registered cell phone.

20) The method according to claim 19 wherein the modifying of the coupon database comprises removing a coupon from the coupon database.
